(19) United States
(12) Patent Application Publication
(10) Pub. No.: US 2016/0142516 A1
(43) Pub. Date: May 19, 2016

(54) METHOD AND SYSTEM FOR TRANSFERRING DATA OVER A LOCAL AREA NETWORK TO A SMART DEVICE

(71) Applicant: Web Service Development, Tokyo (JP)

(72) Inventors: Benjamin Maxwell Collins, Tokyo (JP); Kousei Ogawa, Tokyo (JP)

(21) Appl. No.: 14/943,817

(22) Filed: Nov. 17, 2015

(30) Foreign Application Priority Data
Nov. 19, 2014 (JP) 2014-234318

(51) Int. Cl. H04L 29/06; H04L 29/08

(52) U.S. Cl. CPC H04L 67/42; H04L 67/02; H04L 67/06

(57) ABSTRACT

The present application involves a network system that includes a web application server accessible over the internet and a local area network in communication with the web application server. The system is configured to import web browser application data from the internet to an electronic device and separately import sensitive data via a local area network for viewing on the web browser application. The local area network includes a database server configured to store data, a server configured to process information and regulate the communication of data in the database, and a portable electronic device in communication with the database server and the server.

### BACKGROUND

1. Field of the Invention

The present application relates generally to web technologies and web services displaying and storing of information over a network, and more particularly to situations in which a company manages sensitive data in a local database and selectively displays that information on a portable electronic device to be used in a web application remotely, without transferring the customer data over a public network.

2. Description of Related Art

In recent years it's becoming a more common trend for employees working in the field to reference web applications for customer data. This data is generally stored in the cloud and accessed over the public Internet. As seen in recent history, data stored over the internet is never really secure.

Since the release of HTML5, web content has become more dynamic to the point where not just web pages, but where actual users can go to a web site and interact with web applications directly. The problem with web applications is that browsers follow the standards of the W3, and one of those standards is the same-origin policy. The same-origin policy follows the directive that permits scripts contained in a first web page to access data in a second web page, but only if both web pages have the same origin. An origin is defined as a combination of URI scheme, hostname, and port number. This is done for security reasons so that the cookie of the user using the web service cannot be taken so easily.

However, the problem with same-origin policy is that it centralizes access to web pages and web content to a single end point. Meaning that normal users can access the site, often with the use of logins and cookies to establish a session with the endpoint service. The dynamic that arises with this is that both users and non-users have access to the same end point, allowing anyone to attempt to retrieve data from the end point.

So the issue that arises is how to protect sensitive data from being accessed by unauthorized individuals over the public internet while yet maintaining the accessibility of authorized users to engage this data in remote locations through a web browser. Steps commonly taken are to secure the data stored in the public network through the application of access credentials (i.e. passwords, pins, IDs . . . ). It is evident this is not sufficient as many companies still have “leaks” of information.

It is desirable to provide a system where the data and the service are on the same end point but where sensitive data is stored locally on a server, yet remain accessible through a web browser. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a view of a network system according to the preferred embodiment of the present application;

FIG. 2 is an exemplary schematic of an electronic device for use in the network system of FIG. 1;

FIGS. 3-5 are schematics of the sequences of importing data over a local area network in the network system of FIG. 1;

FIGS. 6-8 are schematics of the sequences of exporting data over the local area network in the network system of FIG. 1;

FIG. 9 is a sample screen shot on a portable electronic device in the network system of FIG. 1, the screen shot showing a method of importing data into a web application;

FIG. 10 is a sample screen shot on a portable electronic device in the network system of FIG. 1, the screen shot showing a method of adding data into a web application;

FIG. 11 is a sample implementation of the network system of FIG. 1; and

FIG. 12 is a sample overview of a portable electronic device used within the network system of FIG. 1.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional data handling and storage methods. Specifically, the system of the present application is configured to selectively permit the display of sensitive information or data on a portable electronic device without having to transmit that information over the internet. Web browser applications are downloaded onto the portable electronic device separately from that of the viewed data. The viewable data is transmitted separately over a local area network onto the portable electronic device for viewing in the web browser application. While viewing, connection over the local area network and the internet is closed to prevent the unauthorized access of the data. The sensitive data within the local area network is not transmitted over the internet. These and other unique features of the assembly are discussed below and illustrated in the accompanying drawings.

The system and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The network assembly of the present application is illustrated in the associated drawings. The assembly includes a web application server accessible over the internet through one or more selected devices, and a local area network. The two networks are in selected communication with one another to provide web application data to one or more portable electronic devices. Referring now to the drawings wherein like reference characters identify corresponding or similar elements in form and function throughout the several views.

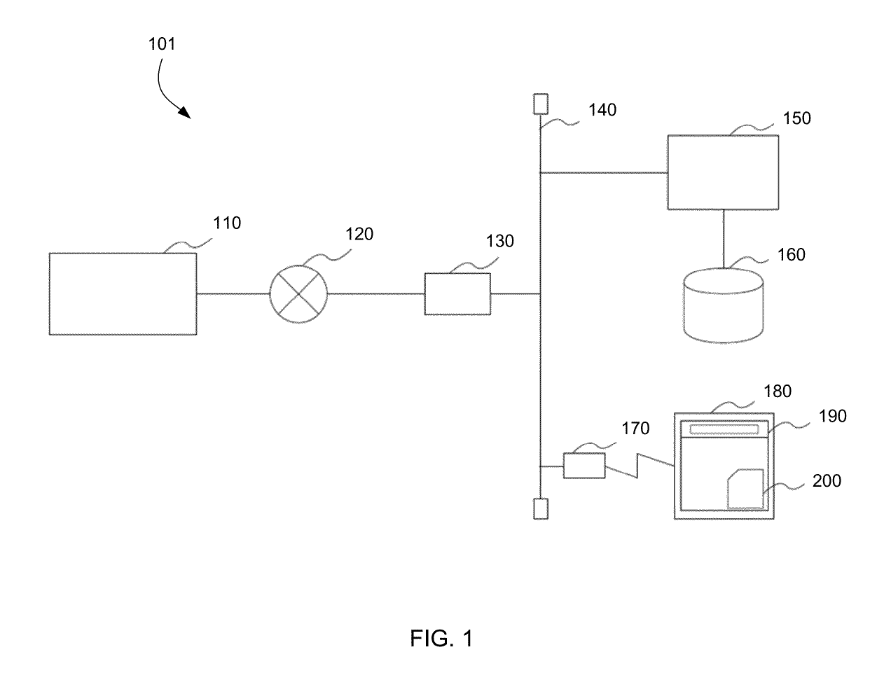

FIG. 1 illustrates network system 101. System 101 includes a web application server 110 accessible over the internet through one or more selected devices, and a local area network 140. The two networks are in selected communication with one another to provide web application data to one or more portable electronic devices 180. Data determined to be sensitive to an end user is stored in network 140 for selected viewing on device 180 in the web application data.

The data is viewed offline from the internet. The overall layout of the devices involved with system 101 is further shown in FIG. 1. Web Application Server 110 is accessible over Internet 120 by a Router 130 or other type of device. Router 130 service as an in between device for network 140 and Internet 120. On network 140 is a Websocket Server 150, database server 160, router 170, and a portable electronic device 180. Server 150 is connected to a Database server 160. Server 150 and database server 160 may be either contained within the same device or may be located within separate devices. On network 140 is a second router 170. Router 170 may be wireless or wired. Router 170 is configured to connect device 180 to network 140. Device 180 has a Web Browser Application 190, which in turn has access to Local Storage 200 on device 180. Local Storage refers to the specification that allows a browser to interface with the device's hard disk. Examples include Local Storage, Session Storage, IndexedDB, WebSQL and any other past or present W3C specifications. It is understood that communications within system 101 may be performed through wired and/or wireless methods.

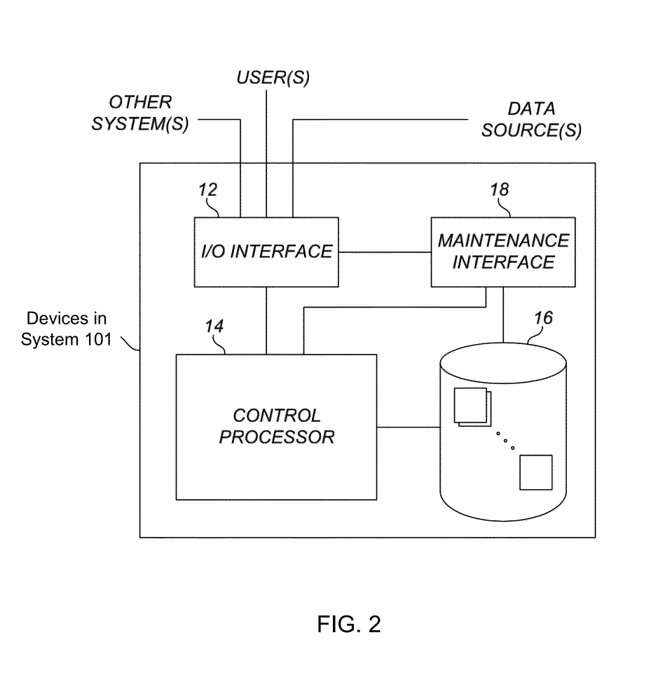

Referring now to FIG. 2 in the drawings, an exemplary schematic of any one of the devices, portable electronic devices, or systems within system 101 is illustrated. System 101 includes various electronic devices (as seen in FIG. 1) in communication with one another to carry out particular tasks associated with the transmission, synchronizing, viewing, importing, and exporting of data. Each device may be operable to carry out tasks on its own. FIG. 2 is a representation of the structure that may be utilized by any of these devices to perform its particular tasks. It is understood that the other components and devices are included within system 101 that may well be represented by this exemplary embodiment. It is also understood that the exemplary structure is not herein limiting to any portion of system 101.

Devices within system 101 may include an input/output (I/O) interface 12, a control processor 14, a database 16, and a maintenance interface 18. Alternative embodiments can combine or distribute the input/output (I/O) interface 12, control processor 14, database 16, and maintenance interface 18 as desired. Embodiments of the system 101 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore, the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the system 101. The I/O interface 12 is in communication with the control processor 14 and database 16 and is configured to provide an interactive link between the buyer and other interested parties. The I/O interface 12 can be configured for allowing one or more users to input information to various devices within the system 101 via any known input device. Examples can include a keyboard, mouse, touch screen, microphone, WI-FI, BLUETOOTH and/or any other desired input device. The I/O interface 12 provides a display portal defining a plurality of visually perceptible elements corresponding to the prediction data. The I/O interface 12 can be configured for allowing one or more users to receive information output from any portion of the system 101 via any known output device. Examples can include a display monitor, a printer, a speaker, and/or any other desired output device. The I/O interface 12 can be configured for allowing other systems to communicate with the system 101. For example, the I/O interface 12 can allow one or more remote computer(s) to access information, input information, and/or remotely instruct any portion of the system 101 to perform one or more of the tasks described herein. The I/O interface 12 can be configured for allowing communication with one or more remote data sources. For example, the I/O interface 12 can allow one or more remote data source(s) to access information, input information, and/or remotely instruct portions of the system 101 to perform one or more of the tasks described herein.

The database 16 provides persistent data storage (computer readable storage media, i.e. hardware) for system 101. Database 16 is in communication with control processor 14 and I/O interface 12. While the term “database” is primarily used, a memory or other suitable data storage arrangement may provide the functionality of the database 16. In alternative embodiments, the database 16 can be integral to or separate from the system 101 and can operate on one or more computers. The database 16 preferably provides non-volatile data storage for any information suitable to support the operation of the system 101, including various types of data necessary to perform the functions and feature discussed below.

The maintenance interface 18 is configured to allow users to maintain desired operation of the system 101. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the control processor 14 and/or the I/O interface 12. This can include, for example, software updates and/or administrative tasks such as security management and/or adjustment of certain tolerance settings.

The control processor 14 can be configured to perform a process or a plurality of processes such as the processes described below in connection with the associated Figures. Additionally, control processor 14 includes software programmed to compile properly communicate with the interested parties. Processor 14 includes a non-transitory computer-readable medium with instructions stored thereon to execute predetermined steps. Various functions of the control processor 14 may be realized.

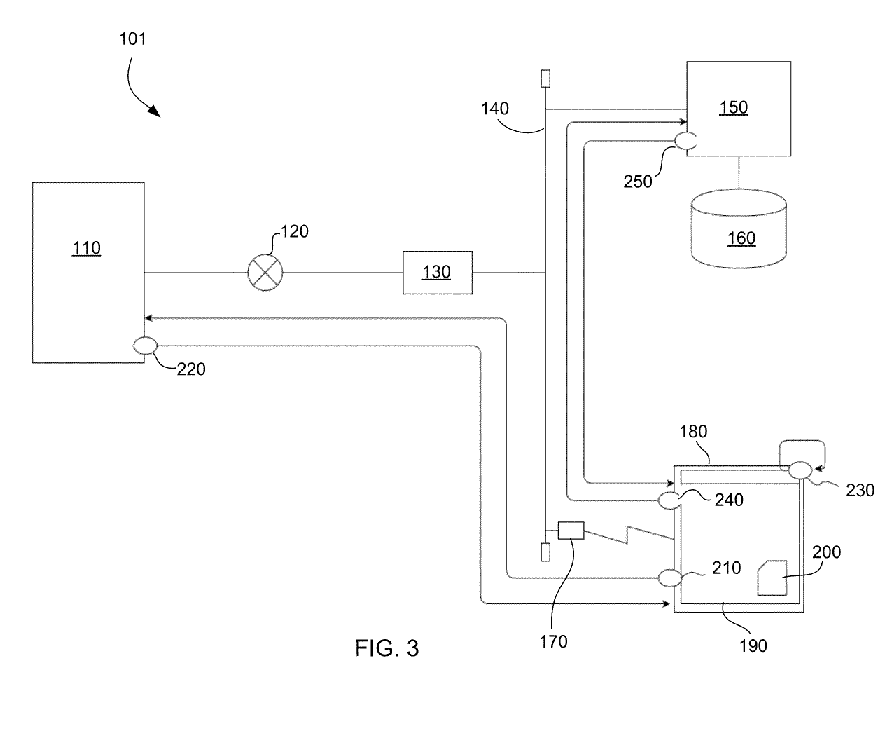

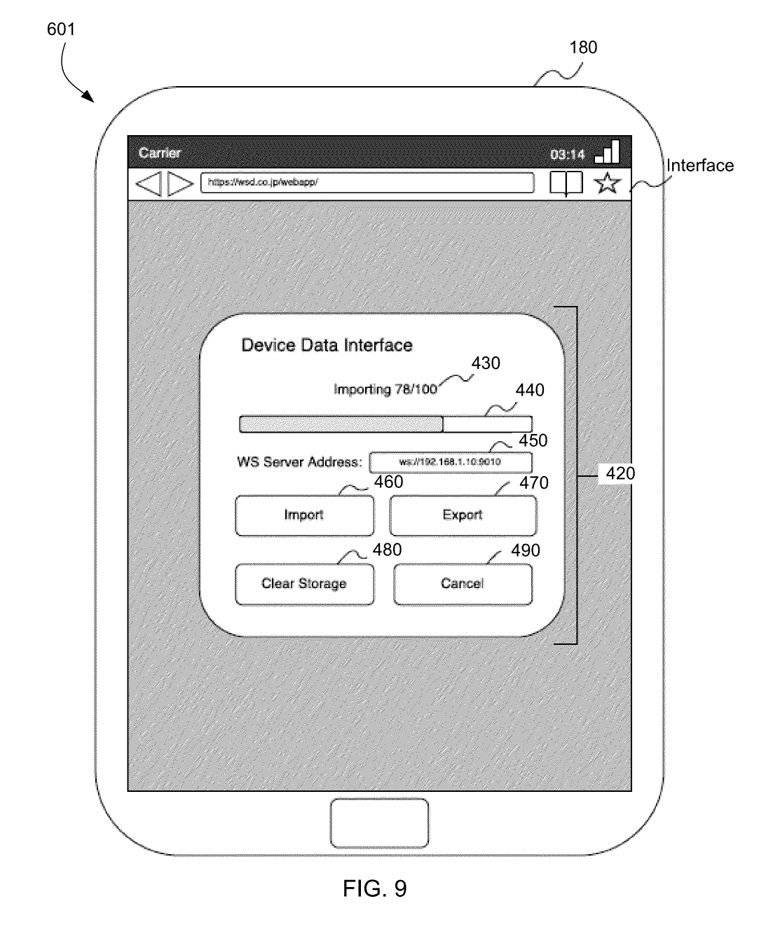

Referring now to FIGS. 3-5 in the drawings, the sequences of importing data over network 140 is illustrated. FIG. 3 depicts the first of three sequences for importing data over network 140 into a Web Application utilizing the technology in the present application. A Web Browser is displayed on device 180. A user enters a URL to access a Web Application hosted on the Web Application Server 110. The browser sends 210 an http request to the application server 110 requesting the web application. The Web Application Server 110 returns 220 web application data for the application to the browser on device 180. Device 180 processing this information for viewing. The user navigates 230 to a screen in the web application to import data from database server 160 (expanded and depicted in FIG. 9). The browser sends 240 a request to open a connection with the server 150 (i.e. WebSocket server). The server 150 responds 250 with a confirmation status response.

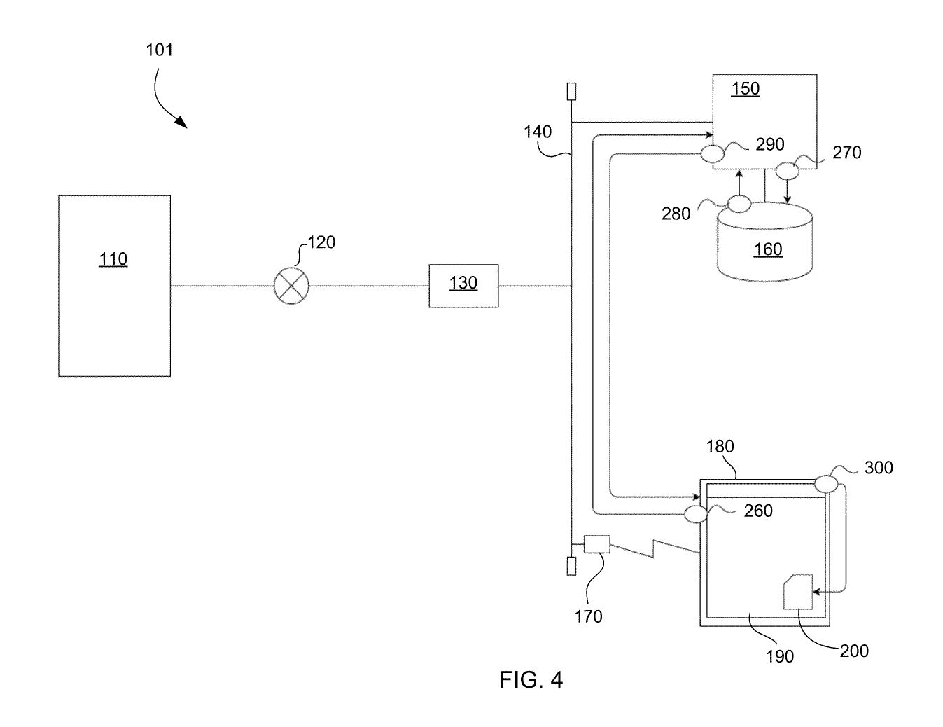

FIG. 4 depicts the second of three sequences for importing data over network 140 into a Web Application on device 180 utilizing the technology in the present application. Once a connection between the Browser on device 180 and server 150 has been established, the Browser sends 260 a request to import data into the web browser application on device 180 for viewing. Server 150 queries 270 the Database Server 160 and the Database Server 160 returns 280 data to Server 150 concerning the query. Server 150 sends 290 the data to the Browser over the websocket connection. The Browser saves 300 to the data from Server 150 to the device's 180 Local Storage 200.

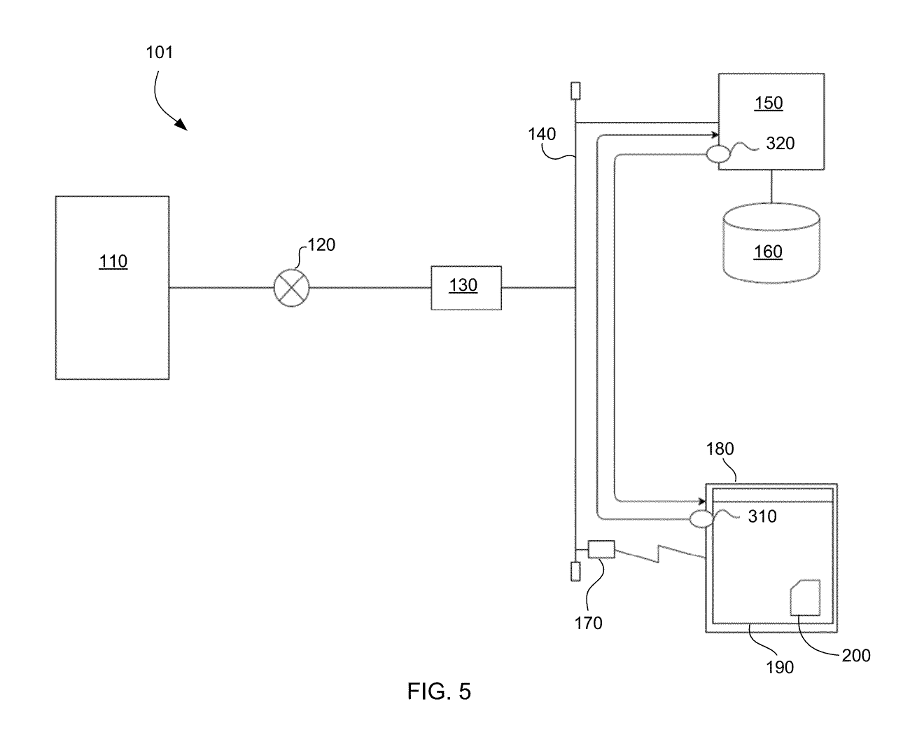

FIG. 5 depicts the third of three sequences for importing data over network 140 into a Web Application on device 180 utilizing the technology in the present application. Once data from the Server 150 has been saved to the device's 180 Local Storage 200, the Browser sends 310 a request to Server 150 to close the websocket connection. Server 150 confirms 320 the request and closes the connection. The connection is active during the transmission of data but not necessarily for the manipulation or viewing of data on device 180.

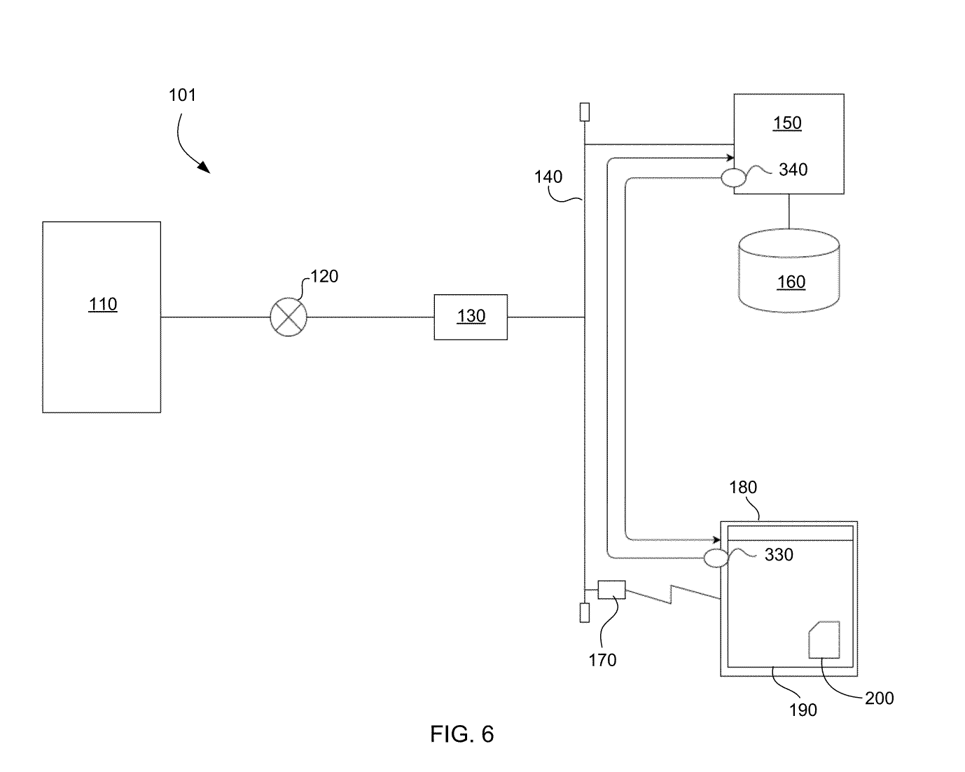

Referring now to FIGS. 6-8 in the drawings, the sequences of exporting data over network 140 is illustrated. FIG. 6 depicts the first of three sequences for exporting data over network 140 into a Web Application on device 180 utilizing the technology in the present application. Once data from database server 160 has been imported into the web browser application on device 180, and then edited or updated or otherwise manipulated, the data can be written back to the Database Server 160 for subsequent use. The Browser sends 330 a request to open a WebSocket connection with the Server 150. The WebSocket server confirms 340 the connection and permits the transmission of data.

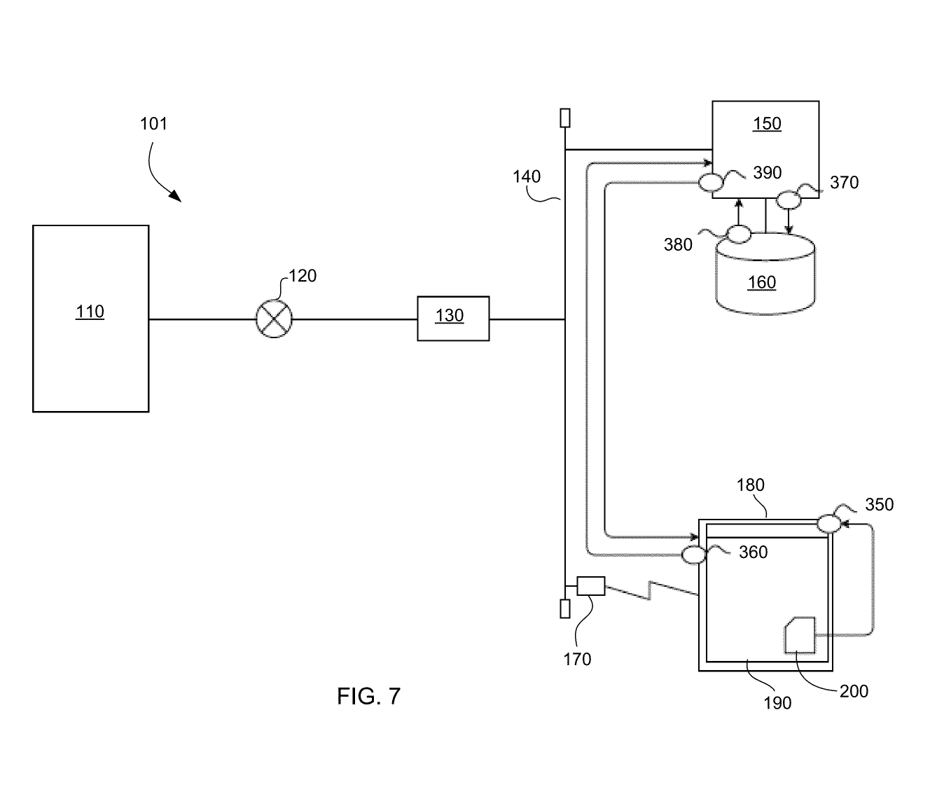

FIG. 7 depicts the second of three sequences for exporting data over network 140 into a Web Application on device 180 utilizing the technology in the present application. Once a websocket connection has been established with the Server 150, the Browser accesses 350 the data stored in the device's 180 Local Storage 200 to compress it into a sendable object (i.e. sample formats: xml, json, binary or otherwise). The Browser sends 360 the data over the websocket connection to the Server 150. The Server 150 sends 370 a request to the Database server 160 to write the data. the Database Server 150 confirms 380 the confirmation of the data. The Server 150 sends 390 a confirmation response to the browser confirming the changes have been reflected on the Database server 160.

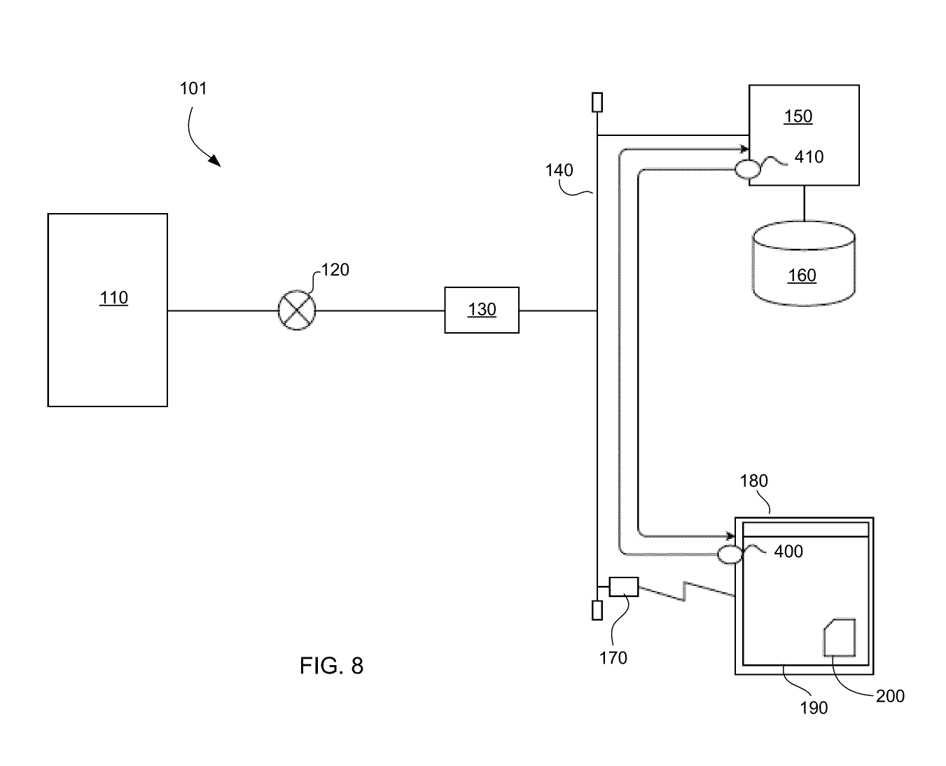

FIG. 8 depicts the third of three sequences for exporting data over network 140 into a Web Application on device 180 utilizing the technology in the present application. Once the Browser has confirmed the data has been written to the Database Server, the Browser sends 400 a message to close the websocket connection to the Server 150. The Server 150 confirms 410 the closure of the connection.

Referring now to FIG. 9 in the drawings, a sample screen shot 601 on a portable electronic device in network system 101 is illustrated. Screen shot 601 shows a method for importing data into the web browser application on device 180. FIG. 9 depicts a possible implementation in a Web Application and how to interact with the functionality from a Graphical User Interface. Menu 420 provides the ability for the user to import the data from database server 160 and server 150. Menu 420 may contain this information in the scope of a larger application. Item 430 shows a progress message which displays to the user the status of data transfer over this technology. Item 440 depicts a progress bar to act as a possible visual confirmation of the status of data transfer or presence therein. Item 450 depicts a text input for the user to enter the IP address of the Server 150 on the Local Area Network 140. Item 460 depicts an Import Button to initiate the transfer of data from a Database server 160 to this device 180 as depicted in FIGS. 2-4. Item 470 depicts an Export Button to initiate the transfer of data from the Device's Local Storage 200 to a Database Server 150 as depicted in FIGS. 5-7. Item 480 depicts a Clear Storage Button to clear or remove any data from Device 180 itself. Item 490 depicts a Cancel Button to close the Dialog box 420 to return to the Web Application.

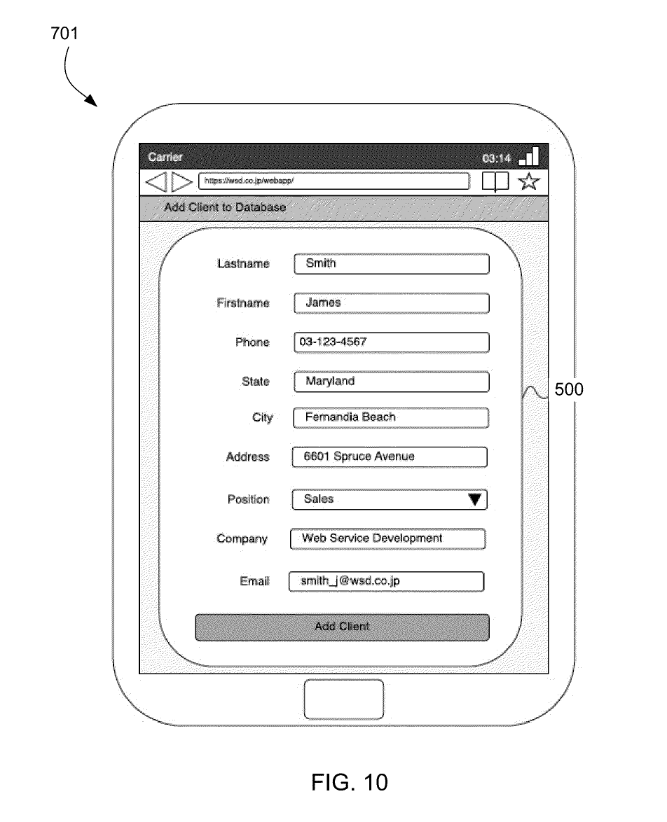

Referring now also to FIG. 10 in the drawings, a sample screen shot 701 on device 180 in network system 101 is illustrated. Screen shot 701 shows a method of adding data into a web application. FIG. 10 depicts a possible implementation of form in the Web Application utilizing this application to add data to device 180 to be returned to the Database 160 when the data is exported. Item 500 depicts a form with several categories involving personal information, such as last name or address. This data is saved to the device's local storage and transferred over network 140 to a Database server 160 so that it is not exposed to the public Internet.

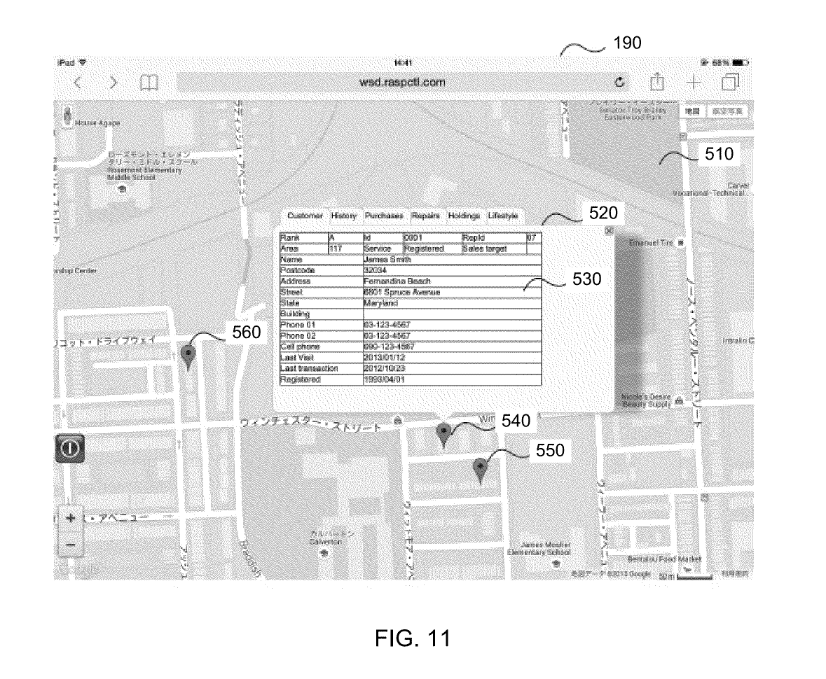

Referring now also to FIG. 11 in the drawings, a sample implementation of the network system 101 is illustrated. FIG. 11 depicts a possible implementation of a Web Application using the characteristics of this present application. FIG. 11 shows the screen of a Browser 190 using a Web Application accessible from a public URL. The application has a Map 510 with Pins 560, 540, and 550 displayed on the map 510. Each pin 540, 550, 560 represents a client stored in the device's Local Storage 200. When a Pin 540, 550, 560 is clicked, an Information Window 520 is displayed to the user with Information 530 from the Local Storage 200 displayed within.

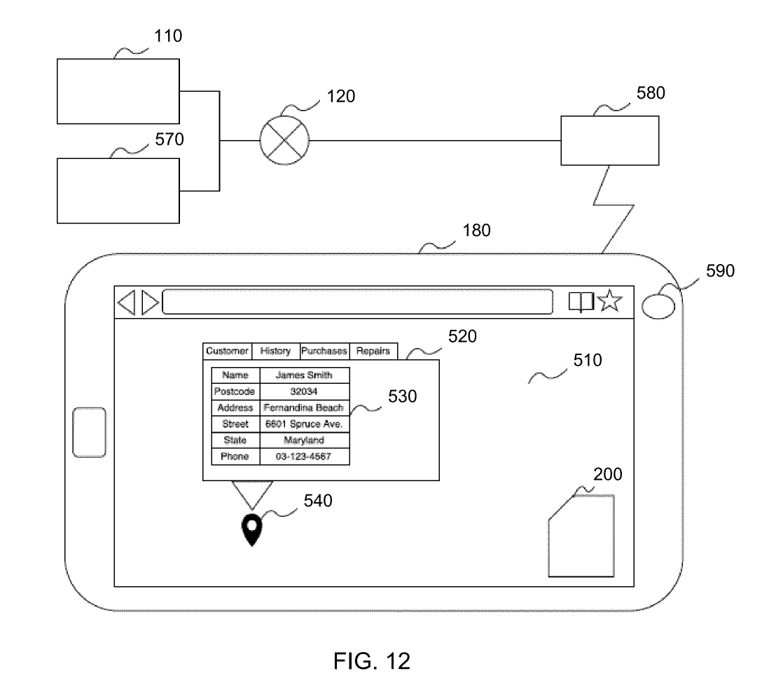

Referring now also to FIG. 12 in the drawings, a sample overview of portable electronic device 180 used within network system 101 is illustrated. FIG. 12 depicts the overview of the status of the Smart Device 180 using the application depicted in FIG. 11. The Smart Device 180 is connected to a Wide Area Network Router 580 over Wi-Fi which is connected over the Internet 120 to a Web Application Server 110 and a Slippy Map Tile Server 570. On the device 180 is the displayed Slippy Map 510 which can be used in conjunction with the Device's GPS device 590 along with Local Storage 200 to create a Sales Force application hosted on Internet 120 while storing the sensitive client data locally in network 140.

The current application has many advantages over the prior art including at least the following: (1) increased security of sensitive data; (2) combination of web browser application and sensitive data via two separate connections to a single electronic device for viewing; (3) ability to modify and manipulate the data on the electronic device; (4) import and export the data from the electronic device to a database over a local area network for storage without exposing the data to the internet.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A network system, comprising:
a web application server accessible over the internet; and
a local area network in communication with the web application server, the local area network including:
a database server configured to store data;
a server configured to process information and regulate the communication of data in the database; and
a portable electronic device in communication with the database server and the server, the portable electronic device configured to include a web browser application;
wherein data stored in the database server is communicated to the web browser application via the local area network.

2. The network system of claim 1, wherein the database server and the server are contained in the same device.

3. The network system of claim 1, wherein the database server and the server are contained in separate devices.

4. The network system of claim 1, wherein the data in the local area network is visible to a remote user via the web browser application without transmission of the data outside the local area network.

5. The network system of claim 1, wherein the local area network communicates via wired and wireless methods.

6. A method of communicating data over a network, comprising:
setting up a local area network for the transmission, storage, and viewing of the data;
storing the data on a database server in the local area network;
communicating the data through the local area network to one or more portable electronic devices; and
viewing the data on the one or more portable electronic devices in a web browser application retrieved over the internet;
wherein the data remains secured over the local area network during viewing on the web browser application.

7. The method of claim 6, further comprising:
importing the data over the local area network into the web browser application, the act of importing the data including:
displaying the web browser application on the one or more portable electronic devices;
entering a URL in the web browser application to access a web application over the internet;
receiving web browser application data from a web application server on the one or more portable electronic devices; and
importing the data into the web browser application by requesting the data be transmitted from a server in the local area network, the data being displayed in the web browser application.

8. The method of claim 7, wherein upon requesting of the data from the server, the server queries a database server for the data, the database server returns the data as requested by the web browser application over the local area network, the web browser application stores the data.

9. The method of claim 7, further comprising:
closing the local area network connection between the one or more portable electronic devices and the server after the web browser application has stored the data.

10. The method of claim 6, further comprising:
establishing a connection between the one or more portable electronic devices and the server; and
exporting modified data from the one or more electronic devices to the database server for storage and subsequent use.

11. The method of claim 10, wherein the modified data is exported in a compressed format to the database server; and
wherein the one or more portable electronic devices receives a confirmation of a successful exportation of the modified data.

12. The method of claim 11, wherein the one or more portable electronic devices closes the connection to the server after confirmation has been received.
